(19) United States
(12) Patent Application Publication
(10) Pub. No.: US 2002/0044671 A1
(43) Pub. Date: Apr. 18, 2002

(54) Loudspeaker

(76) Inventors: Katsuya Shimomura, Mie (JP); Shinsaku Sawa, Mie (JP); Shuji Ido, Osaka (JP); Shigeru Nishida, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/950,060

(22) Filed: Sep. 12, 2001

(30) Foreign Application Priority Data
Jun. 26, 2000 (JP) 2000-190912

(51) Int. Cl. H04R 9/06; H04R 1/02; H04R 1/00

(52) U.S. Cl. 381/386; 381/400; 381/412

(57) ABSTRACT

A loudspeaker comprising: a magnetic circuit; a plastic frame to be coupled with the magnetic circuit; a voice coil disposed in a magnetic gap of the magnetic circuit; and a diaphragm connected with the voice coil. The frame and the magnetic circuit are coupled together by an elastic fastener provided on the frame. In one exemplary embodiment of the present invention, frame and yoke are coupled together by fitting a plurality of elastic fasteners provided on a circle on the bottom surface of the frame with a yoke of the magnetic circuit. In another exemplary embodiment, the elastic fastener is a clip section provided on a circle on the bottom surface of said frame. The frame and magnetic circuit are coupled together by the clip section and an extension provided along the outer circumference of the magnetic circuit. Despite a downsized magnetic circuit, the frame and the yoke can be coupled easily together in a loudspeaker in accordance with the present invention.

### FIELD OF THE INVENTION

The present invention relates to a loudspeaker for use in car-borne audio equipment and the like appliance.

### BACKGROUND OF THE INVENTION

A conventional loudspeaker is described referring to FIG. 9. In FIG. 9, a conventional loudspeaker comprises:

a magnetic circuit A consisting of a magnet 1, a top plate 2, a bottom plate 3 and a yoke 4;

a voice coil 5 provided in the gap of the magnetic circuit A;

a frame 6;

a diaphragm 7; and

a damper 8.

The magnetic circuit A is fixed to the frame 6 by inserting a plurality of protrusions 4a provided at the outer edge of yoke 4 into a plurality of fixing holes 6a provided in the frame 6, and caulking, or swaging, them.

Many of the recent car-borne audio equipment are also boasting of a greater output in their compact overall dimensions. With an aim to make the magnetic circuit A of a speaker small and compact, a magnet of neodymium system, which has a higher magnetic energy as compared with conventional ferrite magnets, is increasingly used for the magnet 1. This requires a subtle work during assembly of a loudspeaker in connecting the magnetic circuit A with the frame 6.

### SUMMARY OF THE INVENTION

A loudspeaker of the present invention comprises a magnetic circuit, a plastic frame to be connected with the magnetic circuit, a voice coil disposed in a magnetic gap of the magnetic circuit, and a diaphragm coupled to the voice coil. In the loudspeaker, the frame and the magnetic circuit are connected together by means of an elastic fastener provided on the frame.

In an example of a loudspeaker in accordance with an exemplary embodiment of the present invention, frame and yoke are connected together by fitting a plurality of elastic fasteners provided on a circle of a bottom surface of the frame to the yoke.

In another exemplary embodiment of the present invention, the elastic fastener is a clip provided on a circle of the bottom of the frame. The frame and the magnetic circuit are connected together by means of the clips and expansions provided along the outer circumference of the magnetic circuit.

### BRIEF DESCRIPTION OF THE DRAWINGS

FIG. 1 is a cross sectional view in half of a loudspeaker in accordance with a first exemplary embodiment of the present invention.

FIG. 2 is a magnified cross sectional view in part used for describing how a yoke and a frame are connected.

FIG. 3A is a cross sectional view showing a magnetic circuit of another loudspeaker in accordance with the first exemplary embodiment of the present invention.

FIG. 3B is a plan view of the yoke.

FIG. 3C is a side view of the another loudspeaker in the first exemplary embodiment of the present invention.

FIG. 3D is a cross sectional view showing the magnified caulked portion.

FIG. 4A is a cross sectional view showing how two constituent portions are combined to form a yoke.

FIG. 4B is a cross sectional view of the yoke finished.

FIG. 5 is a cross sectional view of a magnetic circuit of still another loudspeaker in accordance with the first exemplary embodiment of the present invention.

FIG. 6 is a cross sectional view of a magnetic circuit of still another loudspeaker in accordance with the first exemplary embodiment of the present invention.

FIG. 7 is a cross sectional view of a magnetic circuit of still another loudspeaker in accordance with the first exemplary embodiment of the present invention.

FIG. 8A is a bottom view of a yoke of a loudspeaker in accordance with a second exemplary embodiment of the present invention.

FIG. 8B is a bottom view of a frame.

FIG. 8C is a bottom view showing a state when the yoke and the frame are coupled.

FIG. 9 is a cross sectional view showing in the half portion of a conventional loudspeaker.

### DESCRIPTION OF THE PREFERRED EMBODIMENTS

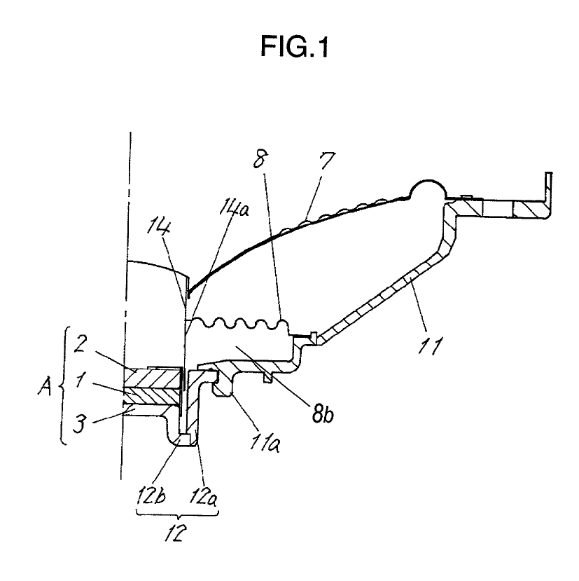

A loudspeaker in accordance an exemplary embodiment of the present invention is described in the following with referrence to FIG. 1 through FIG. 8. Elements similar to those in the conventional technology have the same reference numerals, and the descriptions of those elements are omitted.

### First Embodiment

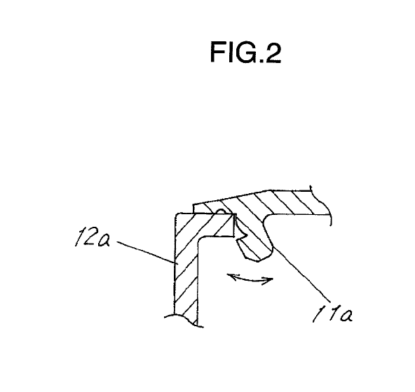

A loudspeaker in a first exemplary embodiment of the present invention is described with reference to FIG. 1 and FIG. 2. Description is made on the differences with the conventional loudspeakers.

The loudspeaker of the present embodiment comprises a voice coil 14 having an air ventilation hole 14a, a plastic frame 11, an elastic fastener 11a provided for a plurality of numbers at the vicinity of a inner circumference of the frame 11, an outer cylindrical portion 12a of a yoke 12 designed to engage at the outer circumference with the elastic fastener 11a, and a bottom portion 12b connected at the outer circumference with the outer cylindrical portion 12a. The yoke 12 comprises the outer cylindrical portion 12a and the bottom portion 12b. Thus the loudspeaker of the present embodiment has an inner magnet type magnetic circuit.

In a loudspeaker of the present embodiment configured as above, the frame 11 and the yoke 12 are fastened together through a snap-in action, by deforming the elastic fastener 11a with the outer circumference of the yoke 12, as illustrated in FIG. 2. In this way, the yoke 12 and the frame 11 can be fastened together through a quite easy operation.

A firm and rigid bonding can be established if an adhesive material is applied around the outer circumference of the yoke 12 and the inner circumference of frame 11.

In the above case, the elastic fastener 11a works also as a temporary holding member, and the assembly operation for a loudspeaker unit can proceed without needing any consideration on a time required for the adhesive material to get hardened.

Furthermore, since the yoke 12 of the loudspeaker in the present embodiment is formed of a component split into two units, there is no need of deep-drawing work of a metal sheet when manufacturing the yoke 12. This contributes to an improved productivity during the production of the yoke 12.

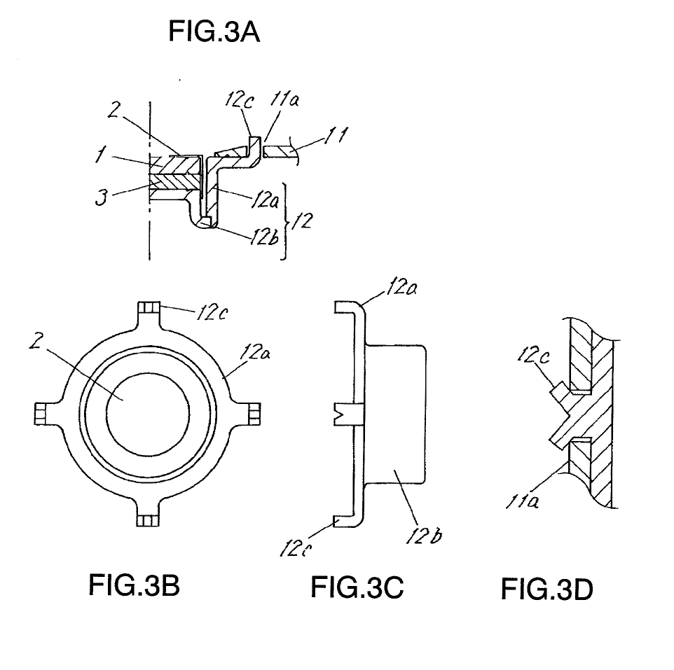

Even in a case where the frame 11 is manufactured with a material other than plastic material, similar advantage of an improved productivity can be obtained by providing a yoke 12 alone with the configuration in which a component is split into two units. In this case, the yoke 12 is provided at the outer circumference edge with a caulking portion 12c as shown in FIG. 3. Then, the yoke 12 can be connected with the frame 11 by inserting the caulking portion 12c through a hole 11a in the frame 11 and expanding the caulking portion 12c inside the hole 11a. The outer cylindrical portion 12a of yoke 12 can be formed using a thin metal sheet.

Next, a structure of the yoke 12, where a component has been split into two units for forming the yoke, is described more in detail.

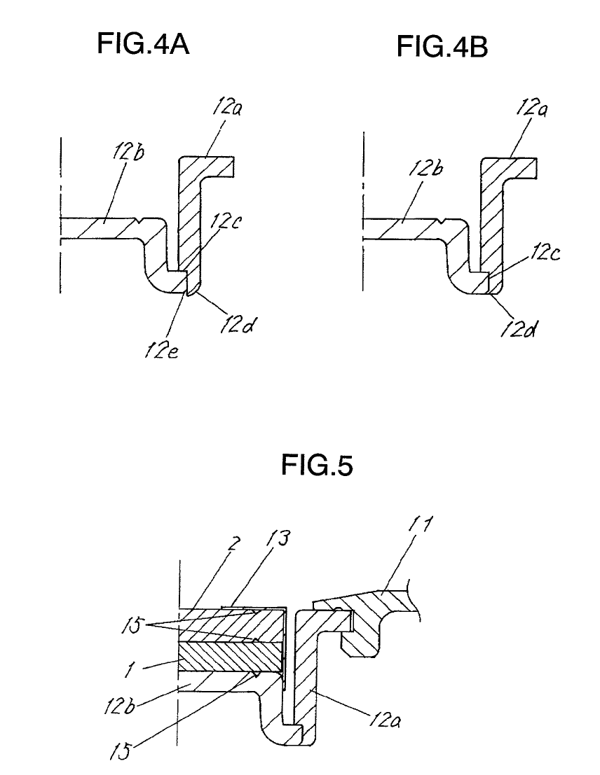

Since the cross sectional form of the yoke is as illustrated in FIGS. 4A, 4B, where the bottom 12b has a lift-up, it has been difficult to form it through a deep drawing process and finish with an plating layer having an uniform thickness.

In the present embodiment, the outer cylindrical portion 12a is provided with a step 12c at the bottom end, and the bottom 12b is provided with a tapered portion 12e at the edge of the outer circumference, as shown in FIGS. 4A, 4B.

The yoke 12 is assembled into one component by fitting the circumference edge of the disk-shaped bottom 12b, which has a lift-up portion in the center, to the step 12c, and fixing the bottom 12b by surrounding it with an edge of the bottom rim 12d of the outer cylindrical portion 12a by a caulking process.

The caulking of the bottom rim 12d of the outer cylindrical portion is conducted along the contour of the tapered portion 12e. Therefore, the caulking can be made easily in a reliable manner. Furthermore, edge of the bottom rim 12d is not folded as far as right angle in the caulking operation; which contributes to prevent deterioration in the caulking strength.

FIG. 5 through FIG. 7 illustrates further application samples of the present embodiment, which aim to enhance heat radiation effects. As shown in FIG. 5 through FIG. 7, the magnetic circuit is provided with a copper cap 13 disposed so as to make a contact with the bottom 12b of the yoke 12. This is intended to transfer a heat from the voice coil 14 to the yoke 12.

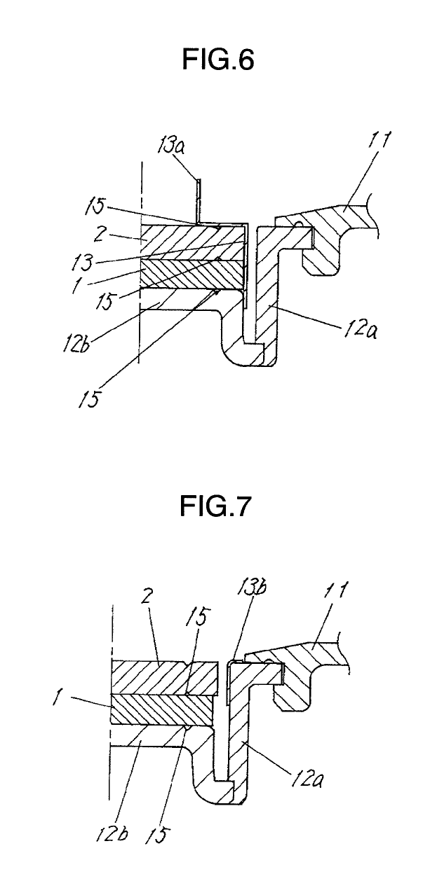

Referring to FIG. 6, a heat radiator 13a attached to the copper cap 13 is aimed to dissipate the heat to a space within the voice coil 14. In FIG. 7, a copper ring 13b provided on the outer cylindrical portion 12a is aimed to transfer the heat generated at the voice coil 14 to the yoke 12 (12a, 12b). The heat radiation effect of the copper cap 13 (13b) contributes to provide loudspeakers that can withstand high input power.

A groove 15 provided along the outer circumference of the top plate 2 and the yoke bottom 12b is a reservoir for preventing an adhesive material for bonding the top plate 2, the yoke bottom 12b and the magnet 1 from squeezing out to the side face.

A loudspeaker of the present embodiment is provided in the voice coil 14 with an air ventilation hole 14a. An air within the voice coil 14 can move to a space 8a formed by the damper 8 when the air is compressed as a result of a movement of the voice coil 14. This reduces a resistance of airflow, and contributes to improve the response characteristic of a loudspeaker during reproduction of low frequency range sounds, when the amplitude becomes great. This also prevents the heat generated at voice coil 14 from staying within the voice coil 14. When the air ventilation hole 14a is disposed at a certain specific location so that it is concealed inside the magnetic gap at a time of great amplitude with the voice coil 14, the airflow resistance at that stage gets a sudden increase. Such a configuration can be used as an air brake for preventing the voice coil 14 from making a collision with the yoke bottom 12b.

### Second Embodiment

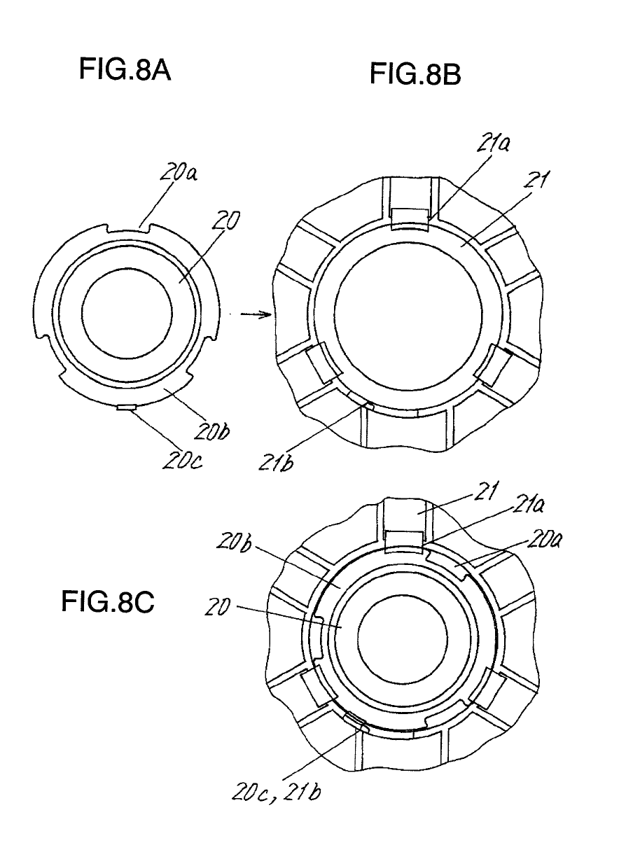

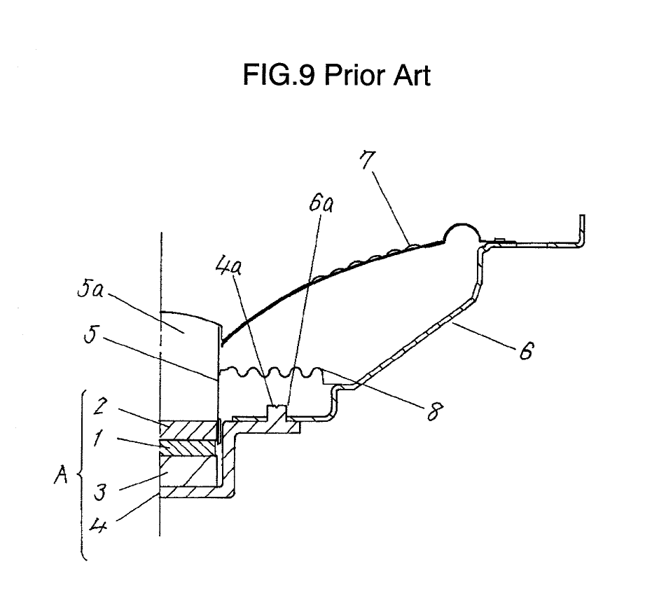

A loudspeaker in accordance with a second exemplary embodiment of the present invention is described with reference to FIGS. 8A, 8B and 8C.

As shown in FIG. 8A, a loudspeaker of the present embodiment comprises a yoke 20 made of a metal, three cuts 20a provided at outer circumference of the yoke 20, three expansions 20b, and a protrusion 20c protruding outward from the expansions 20b. A plastic frame 21 is provided, as shown in FIG. 8B, with three clip sections 21a for coupling with the cuts 20a, and a recess 21b for engagement with the protrusion 20c.

The above-configured yoke 20 and frame 21 are disposed so that the cuts 20a are placed to be fitting to a location corresponding to the clip sections 21a, and then the yoke 20 is revolved so that expansion 20b comes under the clip sections 21a, as shown in FIG. 8. Thus the yoke 20 is now prevented from falling off from the frame 21. As a result of revolution of the yoke 20, the protrusion 20c drops into the recess 21b, which works as a stopper. The expansions 20b are kept retained under the clip sections 21a, and the yoke 20 do not leave from the frame 21. If the clip section 21a is provided with a slightly tapered portion against the expansion 20b, the clip section 21a and the expansion 20b can be brought into an engagement state of compression coupling. In such a configuration, the above-described stopper can be eliminated.

Also in the present embodiment, an adhesive material may be applied in addition, in the same manner as the loudspeaker in the first embodiment. In this case, the adhesive material works to further strengthen the bonding strength between a yoke and a frame. Even when an adhesive material is applied, the structure of the present embodiment works as a tentative holding tool before the adhesive material hardens, so the application of an adhesive agent does not impair productivity for the assembly of loudspeakers.

Although the number of cuts 20a and the corresponding clip sections 21a has been described to be three in the above descriptions, the number is not limited to be three. These elements may be provided for an appropriate number, depending on the overall shape and the dimensions of loudspeakers.

In order to provide an improved heat radiation, such schemes as shown in FIGS. 5-7 used in the loudspeakers in the first embodiment may of course be introduced also to those loudspeakers in the present embodiment.

In the descriptions of the above embodiments of the present invention, a loudspeaker having an inner magnetic type magnetic circuit has mostly been used as an example, where an expensive neodymium magnet is used. The present invention, however, is applicable also to a loudspeaker having an outer magnet type magnetic circuit, by replacing a yoke in the above description with a top plate of an outer magnet type magnetic circuit.

As described above, a frame and a yoke can be easily connected together in a loudspeaker of the present invention, despite the compact and small magnetic circuit thereof. Thus it is sure that the present invention brings about a significant advantage in the industry.

What is claimed is:

1. A loudspeaker comprising:
a magnetic circuit;
a plastic frame coupled with said magnetic circuit;
a voice coil inserted in the magnetic gap of said magnetic circuit; and
a diaphragm connected with said voice coil,
wherein said frame and said magnetic circuit are coupled by an elastic fastener provided on said frame.

2. The loudspeaker of claim 1, wherein said frame and a yoke of said magnetic circuit are coupled together by fitting a plurality of said elastic fasteners provided on a circle of the bottom surface of said frame with said yoke.

3. The loudspeaker of claim 2, wherein said elastic fastener is a clip section provided on a circle of the bottom surface of said frame, said frame and said magnetic circuit being coupled together by said clip section and an expansion provided on an outer circumference of said magnetic circuit.

4. The loudspeaker of claim 3, wherein said frame and said magnetic circuit are coupled together by means of said clip section and an expansion provided on the outer circumference of said yoke, said expansion being designed for insertion underneath said clip section.

5. The loudspeaker of claim 4, wherein a stopper is further provided between said frame and said yoke.

6. The loudspeaker of either one of claims 1 through 5, wherein said magnetic circuit is an inner magnet type magnetic circuit comprising a yoke, a magnet and a plate, said magnet and said plate being overlaid in the central part of said yoke, and said yoke comprising a unit for bottom section and a unit for outer cylindrical section.

7. The loudspeaker of either one of claims 1 though 5, wherein said magnetic circuit is further provided with a heat radiator.

8. A loudspeaker comprising:
a magnetic circuit;
a plastic frame coupled with a yoke of said magnetic circuit;
a voice coil inserted in a magnetic gap of said magnetic circuit; and
a diaphragm connected with said voice coil,
wherein said frame and said yoke are coupled together by fitting a plurality of elastic fasteners provided on said frame with said yoke.

9. A loudspeaker comprising:
a magnetic circuit;
a plastic frame coupled with a yoke of said magnetic circuit;
a voice coil inserted in a magnetic gap of said magnetic circuit; and
a diaphragm connected with said voice coil,
wherein said frame and said yoke are coupled together by means of a clip section provided on a circle of a bottom surface of said frame and an expansion provided on an outer circumference of said yoke, said expansion being designed for insertion underneath said clip section by a revolving action.
